(19) United States
(12) Patent Application Publication
(10) Pub. No.: US 2014/0206424 A1
(43) Pub. Date: Jul. 24, 2014

(54) GAMING SYSTEM WITH PREVIEW

(71) Applicant: William Taylor, Evergreen, CO (US)

(72) Inventor: William Taylor, Evergreen, CO (US)

(21) Appl. No.: 13/942,368

(22) Filed: Jul. 15, 2013

Related U.S. Application Data
(60) Provisional application No. 61/734,995, filed on Dec. 8, 2012.

(51) Int. Cl. G07F 17/32

(52) U.S. Cl. CPC G07F 17/3293
USPC 463/13

(57) ABSTRACT

A gaming system having a game such as 5-Card Draw Poker is disclosed. An initial 5-card hand is dealt and 1 or more possible replacement cards are displayed for each deal card position. If the player chooses to discard one or more dealt cards, each is replaced from an associated set of possible replacement cards. The player makes hold and discard selections with more perfect knowledge of which replacement cards may be drawn at each deal card position.

### BACKGROUND OF THE INVENTION

Slot machines and video poker games are a form of gaming well known in the art. Video poker machines commonly deal 5 cards and let the player decide whether to replace some or all to improve the hand. It is common to offer bonus games, alternative wagering methods and other variations to entice players and generate more play.

To help with the understanding of the present invention the following terms may be used interchangeably, but shall not be considered limiting of other equivalents:
Bonus=feature
Initial cards=deal or dealt cards
Machine=device
Outcome table=list of hands, symbol combinations or events usually associated with a pay schedule
Pay schedule=pay table
Possible replacement cards=associated cards
Processor and memory device=computer or controller
Replacement cards=draw or drawn cards
Wager=bet.

Generally the steps in video draw poker are (1) wager and receive a 5-card hand dealt randomly from a standard 52-card deck, (2) discard 0-5 cards and draw any replacements, (3) evaluate the final 5-card hand against a pay schedule to determine a win or loss.

Many variations of poker exist such as Three Card Poker, Seven Card Stud, Texas Hold'em and Pai Gow, which are dealt, wagered upon and won in different ways. While these games are well known in the art, there are always new variations popping up. Many popular video poker games today offer multipliers that multiply final hand awards depicted in the pay table.

Sigma's Sneak Peek Poker™ was a video game made in the 1990s that showed the first draw card with 100% certainty, but without respect to position. That is, no matter which deal card/s were replaced, this “sneak” card would be drawn next. This game suffered from only knowing one draw card at a time, which was often inadequate to assess strategy for the overall hand. Further, many times this made the game less fun, because frequently it confirmed losers by eliminating winning possibilities. For example, if the sneak card were of the clubs suit, you knew you could not make your dealt hand having 4 hearts into a winning flush.

In U.S. Pat. No. 7,993,191 to Evans, et al, a gaming system is described where a player may, commonly in exchange for a 6^{th} credit wager, view the next draw card like the Sneak Peek Poker™ game. This patent goes on to let the player replace this sneak card with yet another card for a 7^{th} credit wager. While this offers some benefit over Sneak Peek™, it suffers from the same one-at-a-time method and more so by requiring extra steps that slow the game down. A new hand reevaluation, player decision and selection step must take place with each new reveal card. Even if the extra costs (or in some cases reduced returns) to play are acceptable, poker players are notoriously opposed to slowing the game down, and so are game operators. Further the odds are that another sneak card still won't help.

U.S. Pat. No. 7,056,206 to Aoki requires a special deal card, which may be replaced multiple times. Aoki teaches this special card, such as a Black Wizard card, is predetermined and may be replaced more than once from a sequence of replacement cards. Aoki's special card is strictly predetermined at the card level by definition and claim. When decided at deal time this trigger is unaffected by hand outcomes and other events, such as how a card is used or played, that might make the game more interesting. Accordingly such special card is often irrelevant to the hand.

Like Sneak Peek™ and Evans' game Aoki game also suffers from the one-replacement-card-at-a-time method, which precludes a single overall strategy and that may require multiple round/s with more steps that slow the game down. Aoki also lacks a mechanism where his special card is at a position important to the hand or that is relevant or desirable in the first place, a serious weakness.

In application number 20110165926 to Hall his poker game reveals the 2^{nd} to next draw card. This is a curious game with limited appeal or practicality.

In application number 20120004022 to Berman (related to U.S. Pat. No. 8,016,656) his complicated methods all require time-consuming and one or more additional step/s for players to first “select a desired replacement hand” before drawing.

None of the prior art gives you a comprehensive preview of all possible replacement cards initially and at once, in an elegant, easily understood and commercially viable manner. In the prior art an overall strategy is often impossible, because you have limited information at one time. More information comes only in dribs and drabs. These inefficient methods require one or more extra rounds of evaluation, decision making, committing more credits, making selections and/or other steps that dramatically slow down play which both players and operators are known to dislike. That is, with a one-at-a-time next card reveal method the player must reassess the hand each time and make the decision whether to continue or not. Next comes another physical step, at minimum, pressing another button each time. These extra rounds slow down play. Moreover there is rarely or never a limitation on which hands qualify for the one-at-a-time next card reveal feature, so these slow extra rounds may be inherent each and every play.

The present invention offers advantages over the prior art and overcomes their problems. The present invention provides a system and method for card games such as draw poker and other gaming activities typically with a replacement draw that provides better information about what's to come, while using preferred traditional cards and preferably drawing all at once to keep play fast. Thus the present invention is a marked improvement over prior art methods and systems.

### SUMMARY

Several embodiments are described in the present disclosure that relate to a gaming system having or applicable to a 5-Card Draw Poker game, and methods of operating and playing such a game on a gaming device or at a gaming table. Embodiments are described having a feature where the player may view a selection of possible replacement cards and/or bonuses prior to drawing. With better information player strategy is improved as are the odds of obtaining better hand outcomes. Although 5-Card Draw Poker is illustrated in examples below, it should be appreciated the embodiments are not limited to such and may include other video or non-video card based games, table games and other symbol replacement games including, but not limited to, slot machines.

In one embodiment a gaming system is provided having a 5-Card Draw Poker game where 2 additional cards are associated with each dealt card, such additional cards comprising possible replacement card/s for each of the 5 positions in the initial deal hand. Such association is commonly effected by displaying such additional cards adjacent to (often immediately above) each of the 5 initial deal card positions in a smaller form factor. If an initial dealt card is discarded it is replaced with 1 of its 2 associated cards, usually on a random basis.

In some embodiments to compensate for the player advantage of knowing possible replacement cards, the game may be funded at an additional cost, by lowering the average expected payout, by requiring an additional wager at any point in the game, or by any combination. This invention may also be inherent or offered as a bonus.

### BRIEF DESCRIPTION OF THE DRAWINGS

FIG. 1 illustrates an embodiment whereby a dealt 5-Card Draw Poker hand (10) is depicted with a row of 15 possible replacement cards (20). Enticing possible replacement cards (30) are the ace of diamonds and ace of clubs.

FIG. 2 depicts a preferred embodiment where a dealt 5-Card Draw Poker hand (40) is shown with 10 possible replacement cards (50). Two cards are associated with each deal card position.

FIG. 3 shows a common 5-Card Draw Poker pay table for the game Jacks or Better. Awards shown are returns for a 1 credit bet.

FIG. 4 shows a common 5-Card Draw Poker pay table for the game Double Double Bonus Poker. Awards shown are returns for a 1 credit bet.

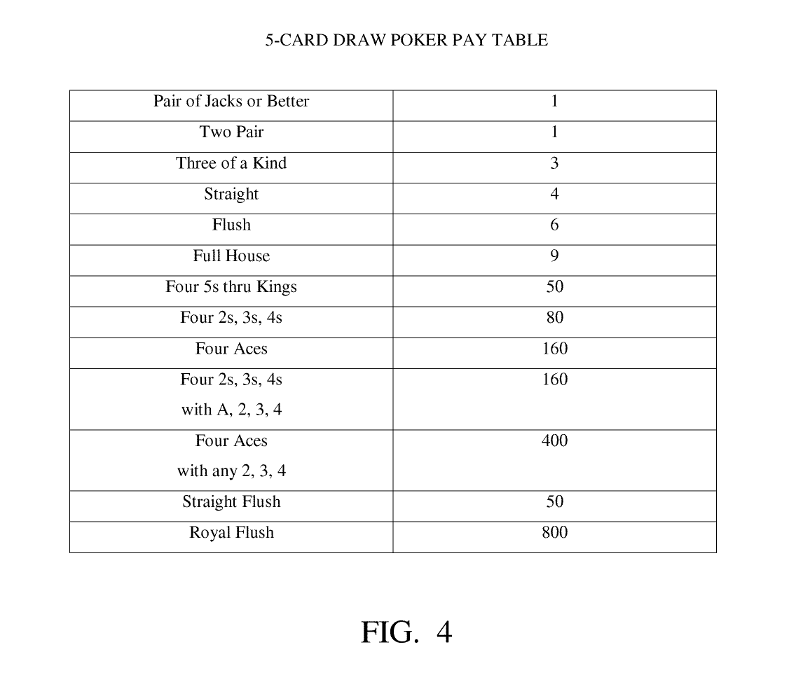

FIG. 5 depicts a 5-Card Draw Poker game screen with hand assist (60).

FIG. 6 shows a pat hand that may be improved by drawing.

FIG. 7 is a flow diagram illustrating a manner of providing a poker game in accordance with the preferred embodiment of the present invention.

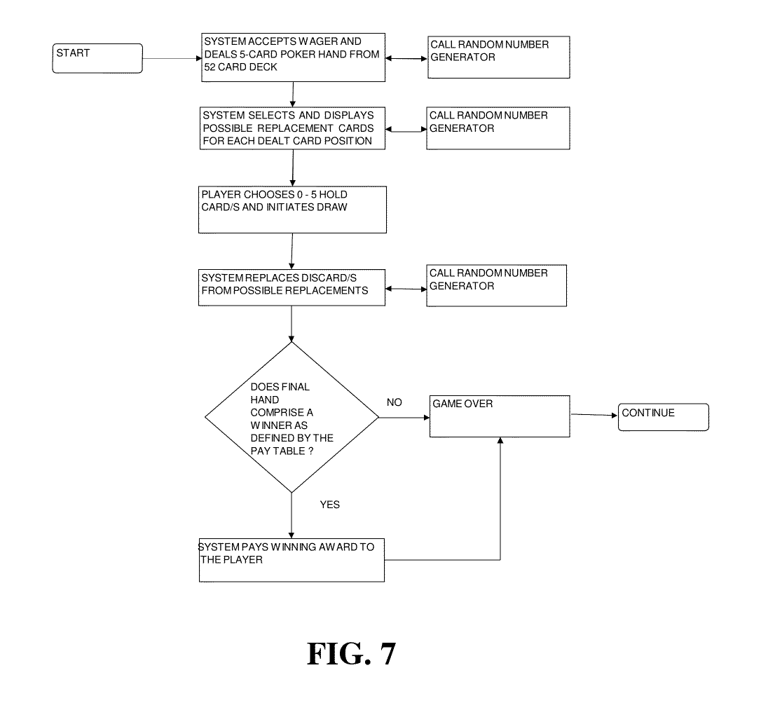

### DETAILED DESCRIPTION OF THE EMBODIMENTS

A primary embodiment for a gaming system having a draw poker game invention is described that reveals a set of possible replacement cards prior to drawing.

A common question video draw poker players ask is, “Are my draw cards just dealt in order, or are they already preselected and behind each deal card already?” It doesn't matter statistically how the replacement cards are selected (or programmed), as long as they are random. But this shows players are keenly interested in how their draw cards are chosen. The present invention satisfies this interest with a compelling new play method.

In the preferred embodiment referred to herein as Sure Poker™ a 5-Card Draw Poker variation begins with a standard 5-card hand dealt randomly by the gaming system device face up from a traditional or virtual deck of 52 playing cards. Ten card backs are displayed above the hand representing 2 possible replacements for each of the 5 deal cards. If the player qualifies with a dealt winner listed upon a pay table then the card backs are overturned and 10 face up cards are displayed in their place, which are taken from the remaining 47 cards in the deck. The player then chooses how to play the hand (that is, which cards to hold and which to replace) with the extra knowledge of what replacement cards are possible for each deal card position. Finally the player draws 0-5 replacement cards, each selected randomly with an equal 1 in 2 chance from the set of 2 associated with each deal card, and the final hand is evaluated against the pay schedule as in normal 5-Card Draw poker.

With more particularity with respect to this 5-Card Video Draw Poker embodiment, the gaming system, upon receipt of a wager, deals a set of 5 playing cards from a virtual deck of 52 common playing cards on a display. If the 5 dealt cards comprise a winner as defined by the pay table or otherwise, then the system displays 10 additional cards taken randomly from the set of 47 cards remaining in the deck, said 5 dealt cards having been removed from the deck and not replaced, and distributes these additional cards in associated positions adjacent to the deal cards on a 2 for 1 basis, such that 2 replacement cards are displayed to the player directly above each of the 5 originally dealt card positions, commonly at a reduced size. The player, by way of an input device, commonly buttons or a touch screen, chooses which of the 5 deal cards to hold, if any, and which to discard and replace, which may be the default if an automatic hold feature is enabled, and if any are chosen for replacement and upon the player choosing to draw then 1 of 2 associated cards are randomly selected to replace each discarded deal card, and the gaming system displays a new hand to the player comprised of any dealt cards not discarded, and any newly selected additional cards to comprise a final 5-card hand. The gaming system or device evaluates such final hand against the pay table and awards the player, typically by adding credits to the player's credit meter.

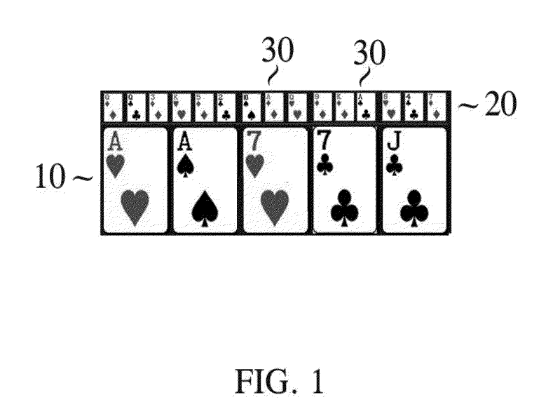

The extra information knowing possible draw cards in advance is a compelling advantage to the player. As shown in FIG. 1, albeit with 3 associated cards per deal card, the player is dealt with 2-pair, aces and sevens which might be held drawing only the non-paired card in a try for a full house. Here, however, holding only the pair of aces is obviously the best strategy, because possible replacements for the pair of 7s include the other 2 aces in the deck (30). There is a 1 in 9 chance then of obtaining 4 aces by discarding and replacing both 7s (1/3×1/3=1/9, or 1 in 9).

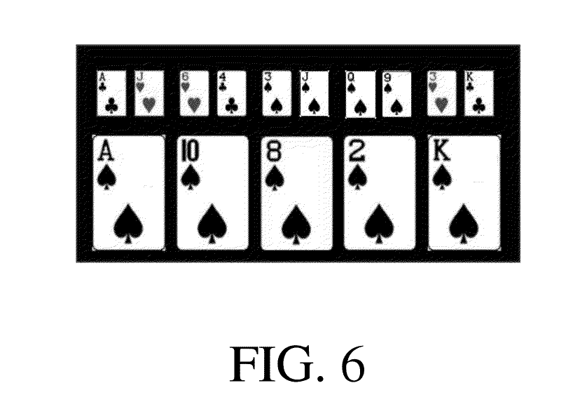

FIG. 6 illustrates a hand that would not normally be drawn to except for the present invention. All 5 cards in a pat hand such as the dealt spade flush pictured would normally be held using optimal strategy. However, in this example the hand cannot be made worse by drawing to the 8 [symbol] and 2 [symbol] and in fact has a 25% chance of being made a much higher paying royal flush.

This method supports an additional bet or higher cost to play for the same return. Other versions may simply take from the customary pay schedule resulting in a lesser expected return. Commonly draw poker requires a bet of 1 to 5 credits per hand. This method may require a minimum bet of 6 or more credits, yet pay awards upon a maximum of 5 credits, with any credit difference comprising an ante bet or additional bet that is required to enable the feature. Greater bets are generally preferred by operators, who profit on a percentage basis.

In another embodiment referred to as Sure Play Poker Double Time™ card faces may be superimposed or replaced with values, multipliers or other indicia. If a card superimposed with a multiplier is drawn, then the card may be used in the player's hand and the multiplier applies to any final award or to final awards that use such card in the winning hand combination (if, for example, it is on one of the Aces in a final hand of 4 Aces). If a multiplier is drawn instead of a card, the multiplier may apply to the final hand, but without replacing the original deal card in that position, or it may be used in another satisfactory manner.

In an alternative embodiment possible replacement cards are not assigned to deal card positions, and any associated card may be drawn to any deal card position.

In another variation the initial and final hands need not consist of 5 cards, but may constitute a 7-card hand or hands or any other number.

In another embodiment there is but a single draw card offered at one or more deal card positions.

In another the draw card reveal trigger is optionally a dealt winning combination, where only cards used or not used in certain or preferred winning combinations are offered replacement/s. For example, if the deal hand is A♡-A♦-3 [symbol] -4 [symbol] -10♡ then only the 3 [symbol] -4 [symbol] -10♡ positions may be offered a draw card and, depending on the game, the A♡-A♦ may or may not be held automatically.

The present invention may be implemented as Sure Play™ Texas Hold'em game at a live table having local or remote opponents, or as a video opponent game or video game played against a pay table with the salient features of the present invention applied to the flop or at any time.

Texas Hold'em is well known in the art. Usually players post an ante, and 2 cards are dealt to each player face down from a standard deck of 52 playing cards. In a pre-flop bet round players can call, raise or fold. After this round the dealer burns the top card to prevent cheating and flops the next 3 cards face up upon the table, which may be used in any player's hand as community cards. The betting process repeats as 2 more community cards are dealt, and finally a showdown occurs and best 5-card hand wins.

As an example using the present invention with Texas Hold'em any pending player or community card/s may be previewed from a subset of cards remaining in the deck. For example, in a live or virtual table game after the pre-flop betting round, the top 6 cards from the deck may be displayed by a suitable means, any 3 of which will be selected randomly and dealt in the flop. This preview radically alters the game, some players will be encouraged to stay in the game longer, and after the preview but before the actual flop there is opportunity for an extra round of betting. Supplemental wagers may be required at any time, such as flop, turn and river. Thus the preview feature adds interest and excitement and possibilities for larger pots, while the integrity of the game rules, awards and play mechanics are preserved.

Other alternative embodiments include:
1. Activating the present invention with or without an additional bet.
2. This invention may be activated or enabled only as a bonus feature and not every play.
3. A variable number or partial set of associated draw cards are options. The set of possible draw cards may number 5, 10, 15 or any number.
4. The set of possible draw cards may be taken from the remaining cards in the current deck, from multiple decks, or from another deck with or without replacement. Duplicate draw cards may or may not be possible.
5. Possible draw cards may not include traditional playing cards at all, but may simply be bonuses such as multipliers or other things of value, detriment or blanks.
6. The set of possible draw cards may or may not be matched, assigned or associated with deal cards. That is, 15 possible draws may simply be extracted from the remaining cards in the deck as a subset and not assigned to specific deal card positions. Odds of any particular draw may or may not be an equal 1 in 15. Any card selections—deals, draws or other—may be weighted with various probabilities and drawn in unequal proportions.
7. Any cards may be selected by use of another means, such as through the use of a wheel, a shooting means or by way of another bonus feature.
8. Draw cards may be priced and bought.
9. This invention may be used with other games. As with many other games, in Go Fish a player may benefit from knowing in advance a reduced set of possible draw cards as opposed to simply any or all cards remaining in the deck.
10. This invention may be used in stud poker and other games where previewed card/s are not replacement draws, per se, but rather are a set from which any dealt or subsequent playing card/s come from. This may be useful for bet and fold decisions among other things.
11. One or more draw cards may be revealed each game, or triggered by another game aspect such as a dealt Queen of Hearts or prior game event, and not only upon a winning deal. Making the reveal trigger random, a dealt 3-of-a-kind (1 in 47) or 3-of-a-kind or better (1 in 35) is also an option. Less frequent bonus hands may be a good choice for games with embedded multipliers, more complex strategy games (including those with 3 or more possible draw cards per dealt card position), or to keep costs to play low while retaining a suitable profit margin for operators.
12. The draw card subset or number of cards revealed may vary in number or type from game to game, or card position to card position. The type of card/s may change from playing cards to multipliers to wild cards to credits or any combination at any time.
0.13. The draw cards may be shared over multiple games played in a collaborative or competitive fashion and drawn down or shared. The set of replacement cards to draw from may vary from player to player. In a draw-down embodiment, 3 possible replacement cards may be taken or used 1 at a time by 3 players, such that the 3^{rd} or last player has only 1 draw possible.
14. Only selected draws may be revealed, if for example, only possible replacements for the 2^{nd} deal card position are displayed. The number of deal cards for which previews are shown may number any by rule, game outcome, player action or otherwise.
15. This invention may be used in multi-hand games where draws are the same or different in multiple hands.
16. A separate or additional game may be played within the draw cards, if, for example, drawing 3 sevens pays a bonus. Or, the subset of draw cards may comprise or be part of a separate hand, blackjack hand, keno numbers pool, 3-card poker hand, numbers selection or other gambling game.
17. One or more possible replacement cards may be added to the number of cards available to form the final hand (or comprising the final hand), such that the best final hand may be made from 6 or more cards, instead of 5. Or, any number of hands may be made having the same or different pay schedules.
18. In some games or variations a draw card may be used at more than one position at the same time, or drawn more than once. Cards drawn may be replaced to the deck.
19. Dealing cards and drawing replacement cards may be done by separate calls to the RNG, or all or any cards offered or selected may be preselected by a single RNG call or otherwise.
20. In Texas Hold'em flop, turn or river draws may be previewed. A subset of remaining cards in the deck may be displayed and drawn from in any manner consistent with the present invention.

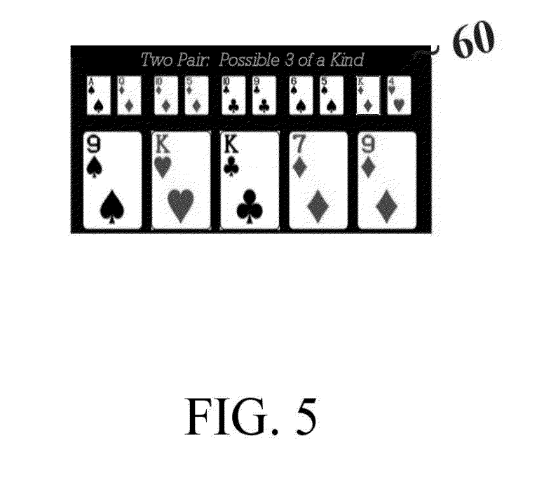

Number of Possible Replacement Cards. While the number of draw cards may be any, and may even vary within the same game or hand, it's usually 2 or 3 per deal card. Three offers more possible combinations, but takes more thought to evaluate. To help players a new “hand assist” feature may be employed. When draw cards are revealed better possible hand/s are displayed in text or otherwise indicated, for example, by highlighting them on the pay table. In the text example, “Jacks or Better: Possible 3 of a kind, 4 of a kind”, Jacks or Better is the current hand and 3 of a kind or 4 of a kind are better possible hands given the draw cards. While in some embodiments hand assist is only practical with a limited number of cards to draw from, else nearly all hands are always possible, it may be very useful to make sure you don't miss an important combination. See FIG. 5.

Gaming System. A gaming system may be designed to achieve any number of objectives, but at its core is a system for managing game play upon gaming devices. A gaming device or system provides support for displays, inputs, controls, and features of a traditional gaming device. It may be configured with different displays or enclosures for player comfort, aesthetics, game enhancements or to serve other purposes.

Gaming devices and systems may be controlled remotely or locally. This invention may be practiced in various configurations for gaming machines or systems where instructions for controlling a game are computerized and are provided with the gaming device originally, by way of a downloadable system where computer instructions are sent to a gaming device by a data network, or both.

Central Server-Remote Execution. In one embodiment computerized instructions for controlling a game is executed by a central server, controller, or remote host. In such a central server remotely controls any game/s and the gaming device is used to display such games and interface with the player.

Central Server-Local Execution. In another embodiment the computerized instructions for controlling any games are transmitted by way of single or multiple communications from a central server, controller, or host to a gaming device or system's local processor and memory devices. The local processor then executes the instructions to control any game or interfaces.

Processor. In one form a gaming device has at least one microprocessor and microcontroller. It may or may not have special purpose integrated circuits. The processor operates to exchange signals with at least one data storage or memory device.

Memory. In another form the processor and the memory device are in the cabinet of the gaming device. The memory device stores program code and instructions to control the gaming device. The memory device also stores other data such as accounting meters, images, events, player inputs, random or pseudo-random number generators, pay table data and game rules.

The memory device may have random access memory: battery-backed non-volatile RAM, and, optionally, magnetic and other forms of RAM. Read only memory, flash memory and EEPROM are also common to achieve the various objectives of operation and security as is common in the art. Other suitable optical, magnetic, or semiconductor memory may operate in conjunction.

Code Storage—Local and Remote. Executable program code may reside locally, and/or in a detachable or removable memory device. Alternatively software, firmware or hardware instructions may be downloaded to the memory device.

Remote Play. In another embodiment an operator or a player can use another memory device to operate, enable or play games on a personal computer, a personal digital assistant, a portable computing device such as a laptop, or other electronic computer platform. In another embodiment the gaming system or device disclosed works over a wireless network. Here the gaming machine may be a hand-held device, a mobile device, or similar wireless device that lets a player play remotely.

Randomness. In another embodiment the gaming system or device randomly generates awards or game events based on statistical probabilities that may be determined by a random number generator. Randomly determined outcomes may in fact be predetermined, truly random, pseudo-random, weighted, constrained or otherwise. Generating outcomes thusly, a specific award or game outcome may never be achieved within a relevant game cycle.

Bingo. In another embodiment the gaming system or device is played as a bingo game. A bingo server calls one or more bingo balls which correlate to game outcomes.

Finite Pool. Some gaming system embodiments contain a fixed number of outcomes. As these outcomes occur, the gaming device system removes them from the finite pool and they are not available to occur again within the current pool. This sort of gaming device system usually defines the number of outcomes at onset and so assures the actual number of wins and losses over the play cycle of a given pool.

Player Bet Data & History. The gaming device has a credit display that shows a player's current number of credits, cash, account balance, or similar data, along with a bet display, the amount wagered, and optionally a player tracking display having personal player tracking information and preferences.

Displays. In another embodiment the gaming system or device includes one or more display devices controlled by the processor and connected physically, wirelessly, or over a data network with the gaming device. The secondary display device may show a primary game, a secondary game or related data such as that for operations, data recording and tracking. These display devices may also advertise within the gaming operation. Said display may function as or comprise an output device.

Display Device. The display device might be a monitor or CRT, LCD, LED, plasma display or other medium serving the same purpose. Displays may be touch-screen operated and controlled, and be any size or form factor such as a square, a rectangle or circle. Images may be projected, reflected or holographic. The display devices of the gaming device are set up to show game images, symbols and such including static, dynamic or animated objects such as mechanical, virtual, or video reels, wheels, playing cards, special effects, movies, persons, places or things and text. The display device may be a mobile display, such as upon a PDA or tablet PC to show at least part of the primary, secondary or auxiliary game or system functions at a remote location.

Player Card Readers. In another embodiment a player may insert an identification card or smart card into a card reader of the gaming device. An identification card or smart card is encoded with a player's identification, credit data, and other relevant information. In another embodiment, a player may carry a portable device, such as a cell phone, a radio frequency identification tag, or other similar device, to communicate such information to the gaming device. Money may be sent to a gaming device by way of electronic funds transfer or similar transmission. Upon player funding, the processor determines the amount of funds entered and shows the corresponding amount on the credit or other suitable display.

Payment Device. In another embodiment a payment device communicates with the processor. A payment acceptor includes a ticket or bill acceptor where the player inserts paper money, a ticket, or voucher and/or a coin slot where the player inserts currency, coins, or tokens. In other embodiments, payment devices may be comprised of validation mechanisms for credit cards, debit cards, credit slips or vouchers.

Input Devices. The gaming device has at least one input device communicating with the processor. The input device is commonly a game activation device, such as a play button for the player to initiate a new game or sequence of events on the gaming device. Sometimes on funding the gaming device plays automatically. More commonly game play is activated when the player presses a play button. A touch-screen may function as an input device.

Service Button. An input device may be a service button. If equipped, pressing this button sends a signal to call an attendant for personal assistance at the device.

Bet Buttons. An input device may be a bet button. The player places a bet by pressing a bet one button. The player may increase the bet by one credit each time which decreases the number of credits shown in the credit display and increases the number of credits shown in the bet display. A convenient bet max button may let the player bet the maximum wager on the gaming device without multiple button presses.

Cash Out Button. A cash out button acts as an input device. Cash out may start a sequence of events to distribute a cash payment of remaining credits or equivalent things of value. Sometimes when the player cashes out, a payment device, such as a ticket, payment, or note generator issues a ticket or credit slip to the player, for redemption by a cashier cage or kiosk. It used to be that cash out prompted such payment in terms of coins or tokens in a coin tray. Any payout mechanism such as refunds back to the player's smart card may be used.

Touch-screen. Another input device is a touch-screen having a touch-screen controller or sensitive overlay to let players interact with displayed images. A touch-screen and controller are connected to a video controller for a player to make decisions and input signals into the gaming device by pressing the touch-screen at various locations. A newer input device is a touch-screen button panel. The gaming device may also have multiple communication ports for communication of the processor with other peripherals, such as external displays, expansion buses, other games, disk drives, keypads, joysticks, pull handle switches, etc. Sound generating devices may also be controlled by sound cards working in collaboration with the processor. Players may control volume and audio equalizer functions by touch-screen.

A/V Devices. In another embodiment, audio/video operation includes a sound generating device with speakers for issuing sound and music that accompanies and/or enhances various modes of the gaming device. Movies may accompany or represent critical functions of the gaming device. Attractive messages may entice potential players to the gaming device, which may be highly customized. Gaming machines may also have a camera working with the processor or independently to take a player image from the gaming device or from an area nearby. Said camera may obtain stills or video images in digital form or otherwise, and may be rebroadcast to the player during a game, and/or used for security, marketing or other purposes.

Game Options. Gaming devices may have any wagering or non-wagering game as the primary or base game. The gaming machine may have some or all of the features of conventional gaming devices. The primary or base game may comprise any suitable reel-type game, card game, lottery game or other game of chance conforming to any computerized representation or implementation, including table games, including those that produce an outcome based on probability data and a wager. Any number of cards may be used or played as in 3-card poker or 7-card poker games. The system may also be used to operate live table games with or without live dealers, games played against the house or other opponents whether real or virtual, and playing at the same table, other tables or remotely. The system may also be linked to other systems and devices for various purposes such as to facilitate game play using automatic playing card shufflers or viewers. Many different wagering games and methods well beyond 5-Card Video Poker may be implemented.

### OBJECTS AND ADVANTAGES

The gaming system described leads to better hands through better decision making. The preferred embodiment shows the possible draw cards for specific card positions in your deal hand. Many advantages are clear.

Player advantages. Players like more information, and this invention addresses a popular question, namely, “How is my draw card found?” Players benefit by having a reduced set to draw from, which reduces uncertainty and clarifies strategy. Knowing you may or may not fill your royal flush on the draw is a good thing to know. It also adds to the fun of the game, because if you are dealt four cards to a royal, for example, and you see your needed fill card is a real possibility you have reason to be excited! Since, in the preferred embodiment, the Sure Poker™ feature is active only with winning hands, the positive nature of the game is always assured. You already have a winner, after all.

Operator advantages. Since most game operators profit from a percentage of the wager, they stand to gain here directly, because this invention commonly requires a greater bet. Even if the bet is unchanged, operators still gain if it's popular and played more. Even if not operated for profit, this invention may be sold and more popular games sell more units. Games using this invention may also be made available on a lease, fee or other basis.

Developers. This new method has many commercially-viable implementations, which provide more options for developers and many derivative game titles. The feature may comprise a game of its own, or be used as a feature in other games. It is compatible with many existing table games, mobile games, internet games, casino games and others.

Other advantages. The preferred embodiment overcomes inherent problems in Sigma's Sneak Peek Poker™ and similar prior art games by showing a plurality of possible draw cards and not just the next card. Here overall game strategy may be decided with a single player decision and no extra button presses.

The present invention is typically enabled at multiple card positions at the same time as opposed to the next-card-only method of Sneak Peek™ and similar games. This gives the player better information on which to base an optimal strategy, while retaining plenty of chance elements to keep it fun. Game speed stays high because of a single player decision round just like in regular draw poker. Moreover if triggered by winning hands only, time-consuming losing hands that would draw more replacement cards on average play normally, saving time. Sure Poker™ grants this benefit of greater knowledge without discouraging play. Using dealt winners as the trigger means all you can do is improve your hand, because you already have a winner to start with!

The following advantages refer generally to a preferred embodiment where the Sure Play™ feature is initiated or triggered upon any dealt winner as defined by the pay table in a 5-Card Draw Poker game, although other triggers, games and pay tables are anticipated.

A great advantage is this invention does not in most embodiments require any extra steps over standard 5-Card Draw Poker. That is, players simply choose any hold cards and draw normally. There are no extra selection steps or button presses that would slow down play that poker players and operators dislike. Thus Sure Poker™ offers an elegant implementation that plays easily, intuitively and fast.

In fact since many accomplished and professional video poker players already play as fast as the gaming system allows the present invention offers them a new strategic challenge in a delightful way, since Sure Play™ provides more perfect information.

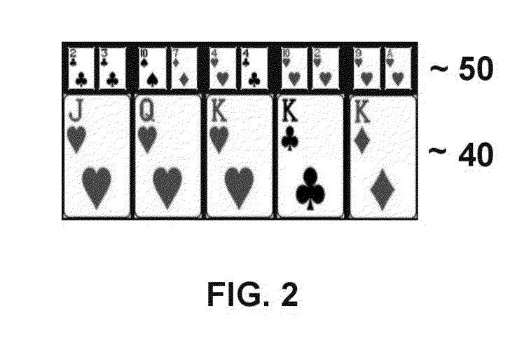

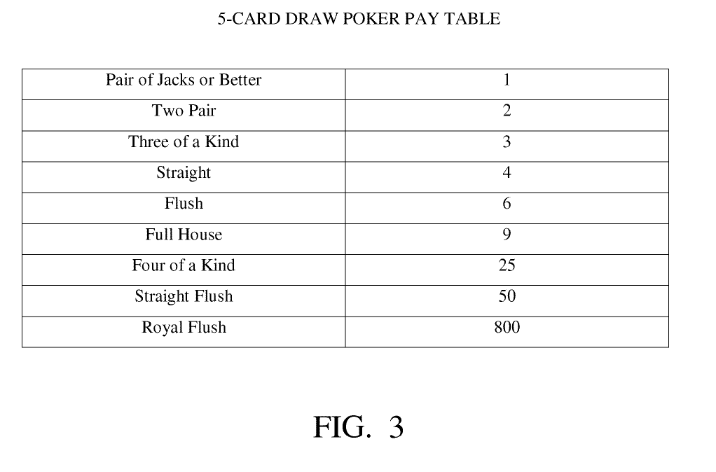

In the J♡-Q♡-K♡-K [symbol] -K♦ hand dealt and illustrated in FIG. 2 the usual optimal strategy for a common pay table as in FIG. 3 is to keep the 3 Kings. But in this example holding the hearts guarantees a flush, and there is a 50% chance at a straight or royal flush! It's easy and intuitive to play.

In the preferred embodiment the Sure Play™ feature is always a good thing—it can only make your winning hand better. Bigger winners naturally result when you have better information as to how to play your hand.

A key advantage of using a reveal trigger such as upon dealt winners is that non-winning deal hands are unaffected. Such losing deals draw more replacement cards on average than winning deals. The more cards drawn, the more potential card combinations to consider and, in general, the more time it takes to evaluate. Since about 80% of deals are losers, game play may be slowed down if all hands showed a plurality of possible draw cards. The preferred embodiment practices an elegant solution to this problem.

Sure Play™ offers a striking and attractive visual presentation.

Sure Play™ plays naturally. It's easy. There are no extra steps or selections. Choose your hold cards and draw as usual.

Sure Play™ adds a brand new fun factor. When you see the cards you want and know you have a good chance to get them, it's worth sharing with friends! Such sharing may be accomplished by the gaming system over data networks involving social media platforms or otherwise.

Sure Play™ simplifies strategy. In 5-Card Draw Poker about 20% of hands are dealt winners. The vast majority of these draw 3 cards or less. Drawing 3 cards from 47 remaining has >16,000 combinations. But there are only 8 ways to draw 3 cards when each dealt position has only 2 associated replacement cards and only 27 ways with 3. This simplifies decision making and keeps play fast.

Sure Play™ appeals to novices, casual players and pros alike. The present invention may have special appeal to novice players and may even be used as a training tool.

Sure Play™ does not alter randomness. It simply reveals the next cards in the deck.

Sure Play™ resolves many common conflict hands (where the best strategic plays yield roughly equal expected values) whether to go for one hand or another. Referring now to FIG. 6, even pat hands, those where you would normally hold all 5 cards, may be improved!

Sure Play™ is unique in draw poker and overcomes problems with prior art games that require extra steps or selections to see and/or utilize possible replacement cards, a big downside.

Sure Play™ increases the expected value of winners. Some popular games do this by awarding random multipliers or rewarding certain hands such as flushes. But here this is accomplished without altering the pay table by making better hands in the first place!

Sure Play™ works as a single hand game, multi-hand game, or multiple bonus game where a plurality of bonus features may be combined to offer more compelling games and drive greater bets

Sure Play™ does not change player goals, it simply makes winning hands better. You still want the same hands in rank order or as dictated by a pay table.

Strategy changes are limited in a good way. You cannot lose unless you choose to throw a winner away.

Sure Play™ has important advantages over prior art games such as Sneak Peek Poker™ and others that reveal only one card or one card at a time. Here you commonly have a winner to begin with and multiple possibilities are revealed instead of only 1 definitive and often demoralizing next card.

Sure Play™ is especially valuable in certain games that pay extra for achieving hands in a predetermined order, because possible replacement cards are usually specific by deal card position.

In summary Sure Play™ offers a gaming system with a unique preview that gives players more specific information on which to base hold and discard decisions in games like 5-Card Video Poker, leading to better hands of higher average value. The Sure Play™ system has many compelling advantages, not least of which is its superiority over prior art preview games that offer less valuable information and that operate in clumsy ways that slow down play.

This disclosure is provided to allow practice of the invention by those skilled in the art without undue experimentation, including the best mode presently contemplated and the presently preferred embodiment. There are numerous variations falling within the scope of the invention. Any subset or combination of the above methods, player selections, means or forms of wagering or paying, finding winners and losers and/or displaying or otherwise presenting selections, associations or outcomes may be used. This invention may be employed with any combination of games or options including, but not limited to, bonuses, random or mystery awards, multipliers, progressives, other games, player skill components, other features, side bets, wagering or play methods and may be practiced competitively or collaboratively. This invention may be employed in whole or in part, or itself as a bonus, add-on or otherwise in conjunction with new or traditional gaming devices, methods or systems. Thus, these and all embodiments described should be viewed as illustrative, rather than limiting. Nothing in this disclosure should be taken to limit the scope of the invention, which is susceptible to numerous alterations, equivalents and substitutions without departing from the scope and spirit of the invention. The scope of the invention is to be understood from the appended claims.

I claim:

1. A method of operating a gaming system, said method comprising: (a) causing at least one processor to execute a plurality of instructions stored in at least one memory device to operate with at least one input device to receive a wager from a player for a play of a game; (b) after receiving the wager, causing the at least one processor to execute the plurality of instructions stored in the at least one memory device to determine a plurality of playing cards for an initial player hand for said play of the game from a virtual deck of playing cards; (c) prior to displaying the plurality of cards of the initial player hand face-up, causing the at least one processor to execute the plurality of instructions stored in the at least one memory device to operate with the at least one input device to enable the player to place a first supplemental wager; (d) causing the at least one processor to execute the plurality of instructions stored in the at least one memory device to operate with at least one display device to display the plurality of cards of the initial player hand face-up; (e) if the player places the first supplemental wager: (A) causing the at least one processor to execute the plurality of instructions stored in the at least one memory device to operate with the at least one display device to display a set of possible draw cards face-up from the virtual deck of playing cards; (B) causing the at least one processor to execute the plurality of instructions stored in the at least one memory device to operate with the at least one input device to enable the player to designate a quantity of the playing cards of the initial player hand to replace; (C) if the quantity of designated playing cards to replace is at least one: (1) causing the at least one processor to execute the plurality of instructions stored in the at least one memory device to form a second player hand by replacing designated playing cards individually from the set of possible draw cards associated with each dealt card position; (f) if the player does not place the first supplemental wager: (A) causing the at least one processor to execute the plurality of instructions stored in the at least one memory device to operate with the at least one input device to enable the player to designate a quantity of the playing cards of the initial player hand to replace; and (B) causing the at least one processor to execute the plurality of instructions stored in the at least one memory device to form the second player hand by replacing the designated playing cards with draw cards from the virtual deck of playing cards; (g) causing the at least one processor to execute the plurality of instructions stored in the at least one memory device to determine a rank of the second player hand; (h) causing the at least one processor to execute the plurality of instructions stored in the at least one memory device to determine any awards to be provided to the player based on the rank of the second player hand and according to a pay table; and (i) causing the at least one processor to execute the plurality of instructions stored in the at least one memory device to cause any determined awards to be provided to the player.

2. A method of operating a gaming system, said method comprising:
(a) inputting data associated with a primary wager through at least one input device;
(b) executing a plurality of instructions stored in at least one memory device through at least one processor to operate the play of a game; the play of the game comprising the steps of:
(i) displaying a plurality of playing cards face-up for an initial player hand for said play of a game from a virtual deck of playing cards on at least one display device;
(ii) displaying at least two replacement cards face-up from the virtual deck of playing cards for at least one playing card of the initial player hand, each of the at least two replacement cards associated with the at least one playing card of the initial hand;
(iii) indicating playing cards from the initial player hand to hold and playing cards from the initial hand to replace;
(iv) discarding the playing cards of the initial hand indicated to be replaced;
(v) replacing the at least one playing card of the initial hand with one of the at least two replacement cards associated with the discarded playing card from the initial hand to form a final hand;
(vi) comparing the final hand to a plurality of outcomes from a table of outcomes; and
(vii) providing a payout in accordance with a payout amount assigned to the winning outcome if the final hand matches a winning outcome from the table of outcomes.

3. The method of claim 2 wherein the replacing the at least one playing card of the initial hand with one of the at least two replacement cards associated with the discarded playing card from the initial hand is random.

4. The method of claim 2 wherein the payout amount assigned to the winning outcome if the final hand matches a winning outcome from the table of outcomes is a multiple of the primary wager.

5. The method of claim 2 further comprising: inputting data associated with a supplemental wager through the at least one input device as a condition to displaying the at least two replacement cards for at least one playing card of the initial hand.

6. The method of claim 5, wherein the supplemental wager is wagered subsequent to the display of the initial playing hand and the at least two replacement cards for at least one playing card of the initial hand.

7. The method of claim 5, wherein the at least one input device for wagering the supplemental wager is made inactive if the initial hand does not match one or more supplemental wager outcomes from the plurality of outcomes from the outcome table, the supplemental wager outcomes including one, none or all of the winning outcomes.

8. A method for playing a game comprising: receiving a wager from a player to play the game; dealing a first plurality of face-up cards from a deck to make a card hand; dealing a plurality of possible replacement cards, at least two of the replacement cards in a position associated with one of the cards in said first plurality of face-up cards, the plurality of possible replacement cards comprised of any cards remaining in the deck; selecting one, none or all of the first plurality of face-up cards to discard; replacing any discarded face-up cards with one of the cards from the plurality of possible replacement cards; and determining a poker hand ranking of the card hand.

9. The method of claim 8 wherein the game is played on a video poker machine.

10. The method of claim 9 wherein prior to selecting one, none or all of the first plurality of face-up cards to discard one or more of the highest possible poker hand rankings are displayed to the player.

11. The method of claim 8 wherein the game is played at a live table.
